(19) United States
(12) Patent Application Publication
(10) Pub. No.: US 2025/0038901 A1
(43) Pub. Date: Jan. 30, 2025

(54) METHODS AND APPARATUSES FOR MULTI-USER SCHEDULING WITH BEAM SQUINTING

(71) Applicant: Google LLC, Mountain View, CA (US)

(72) Inventors: Jibing Wang, San Jose, CA (US); Erik Richard Stauffer, Mountain View, CA (US)

(21) Appl. No.: 18/773,383

(22) Filed: Jul. 15, 2024

Related U.S. Application Data
(60) Provisional application No. 63/529,334, filed on Jul. 27, 2023.

(51) Int. Cl. H04L 5/00; H04W 72/044

(52) U.S. Cl. CPC H04L 5/0023; H04W 72/044

(57) ABSTRACT

A network entity transmits, to a first UE and a second UE, a plurality of reference signals via a plurality of beams corresponding to a plurality of subbands, receives, from the first UE, a first indicator of a first beam of the plurality of beams and a first subband of the plurality of subbands satisfying a first threshold, receives, from the second UE, a second indicator of the first beam and a second subband of the plurality of subbands satisfying a second threshold, the second subband being different from the first subband. The network entity further communicates, with the first UE in a slot, a first communication via the first beam and the first subband, and communicates, with the second UE in the slot, a second communication via the first beam and the second subband.

### CROSS REFERENCE TO RELATED APPLICATION(S)

This application claims the benefit of and priority to U.S. Provisional Application Ser. No. 63/529,334, entitled “Methods and Apparatuses for Multi-User Scheduling with Beam Squinting” and filed on Jul. 27, 2023, which is expressly incorporated by reference herein in its entirety.

### TECHNICAL FIELD

The present disclosure relates generally to wireless communication, and more particularly, to methods and apparatuses for multi-user scheduling with beam squinting.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In fifth generation (5G) advanced and sixth generation (6G) wireless technology, millimeter wave (mmWave) and terahertz (THz) frequency bands can provide a communications resource for a user equipment (UE) and a network entity. While beamforming is used for mmWave and THz bands in order to increase a link budget, beam squinting effects of a wideband channel can provide challenges for analog beamforming in directing the beam to the UE. “Beam squinting”, as used herein, refers to an unfocusing of the intended direction of the beam across frequency when phase shifting is used to steer the direction of the beam. The beam squinting effect can be caused by the frequency dependence of the magnitude of the phase shift in analog beamforming, thereby causing a deviation of the arrival angle from boresight (the intended direction) at the UE. The present disclosure proposes to take advantage of the beam squinting effect by frequency division multiplexing (FDM) users on the beams.

A network entity (e.g., a base station, a radio unit (RU), a distributed unit (DU), a central unit (CU)) can partition the wideband frequency channel into subbands (e.g., 2, 3, 4, or more subbands). The network entity can transmit reference signals (e.g., channel state information reference signals (CSI-RSs), phase tracking reference signals (PTRSs), synchronization signal blocks (SSBs), and/or other suitable reference signals) over a plurality of beams to a group of UEs. The number of beams can be based on the configuration of the transmission reception point (TRP) of the network entity. Accordingly, the network entity transmits the reference signals via each of the beams using a wideband frequency channel partitioned into subbands. The UEs can measure the reference signals across the subbands. For example, the UEs can measure a reference signal received power (RSRP), received signal strength indication (RSSI), and/or a signal-to-interference plus noise ratio (SINR) of the reference signals. In some aspects, the UEs may compare the measurements to a threshold and report to the network entity identifiers of the beam/subband combinations satisfying the threshold. Additionally or alternatively, the UEs may report the values of the measurements to the network entity. For example, the UEs may report the highest RSRP, SINR, and/or RSSI of a measured beam/subband combination. The UE may additionally report the measurements of other measured beam(s)/subband(s) (e.g., a subset of the next highest measurement(s)). The additional measurements may be reported as a delta from the highest reported measurements.

In some aspects, the network entity can transmit a request (e.g., via radio resource control (RRC)) to the UEs requesting a UE capability indicator to determine whether the UEs support subband partitioning and measurement reporting. In response, the UEs can transmit a message (e.g., via a physical uplink control channel (PUCCH)) to the network entity indicating support for subband reporting by the UE.

In some aspects, the network entity can transmit a configuration (e.g., via RRC) to the UEs indicating parameters of the subband partitioning and measurement. The parameters can include the subband frequency ranges, a value of the measurement threshold, a format of the measurement reporting, etc. In some aspects, the network entity can configure transmission configuration indicators (TCIs) that map identifiers of each beam to identifiers of the subbands.

After receiving the measurement reports, the network entity can transmit (e.g., via downlink control information (DCI) on a physical downlink control channel (PDCCH)) a schedule for downlink communications (e.g., a dynamic schedule or semi-persistent schedule) that indicates resources for physical downlink shared channel (PDSCH). The resources can indicate a beam identifier, a subband identifier, and a time slot identifier for the scheduled PDSCH.

After transmitting the downlink communication schedule, the network entity can transmit downlink communications to different UEs using the same time slot and the same beam but using different subbands. By taking advantage of the deviation from boresight direction due to frequency dependent beam squinting, spectral efficiency and throughput of the network can be increased.

In some aspects, the downlink channel can have reciprocity with the uplink channel. In this case, the uplink channel can also benefit from frequency dependent beam squinting. In this regard, the network entity can transmit a schedule (e.g., an uplink grant) to multiple UEs indicating resources comprising a time slot, a beam identifier, and a subband identifier. Each of the multiple UEs can be scheduled in the same time slot and same beam identifier but using a different subband.

According to some aspects, a network entity transmits, to a first UE and a second UE, a plurality of reference signals via a plurality of beams corresponding to a plurality of subbands. The network entity receives, from the first UE, a first indicator of a first beam of the plurality of beams and a first subband of the plurality of subbands satisfying a first threshold. The network entity receives, from the second UE, a second indicator of the first beam of the plurality of beams and a second subband of the plurality of subbands satisfying a second threshold, the second subband being different from the first subband. The network entity communicates, with the first UE in a slot, a first communication via the first beam and the first subband. The network entity communicates, with the second UE in the slot, a second communication via the first beam and the second subband.

According to some aspects, a UE receives, from a network entity, a plurality of reference signals via a plurality of beams corresponding to a plurality of subbands. The UE transmits, to the network entity, an indicator of a first beam of the plurality of beams and a first subband of the plurality of subbands satisfying a threshold. The UE communicates, with the network entity in a slot, a first communication via the first beam and the first subband. A second communication associated with another UE is communicated in the slot, via the first beam and a second subband of the plurality of subbands, the second subband being different from the first subband.

### BRIEF DESCRIPTION OF THE DRAWINGS

FIG. 1 illustrates a diagram of a wireless communications system that includes a plurality of user equipments (UEs) and network entities in communication over one or more cells according to an embodiment.

FIG. 2 is a diagram illustrating beam squinting effect on a wideband frequency channel according to an embodiment.

FIG. 3 is a diagram illustrating subband communication between a network entity and UEs according to an embodiment.

FIG. 4 is a signal flow diagram of a method of multi-user scheduling with beam squinting according to an embodiment.

FIG. 5 is a flowchart of a method of multi-user scheduling with beam squinting at a network entity according to an embodiment.

FIG. 6 is a flowchart of a method of multi-user scheduling with beam squinting at a UE according to an embodiment.

FIG. 7 is a diagram illustrating a hardware implementation for an example UE apparatus according to an embodiment.

FIG. 8 is a diagram illustrating a hardware implementation for one or more example network entities according to an embodiment.

### DETAILED DESCRIPTION

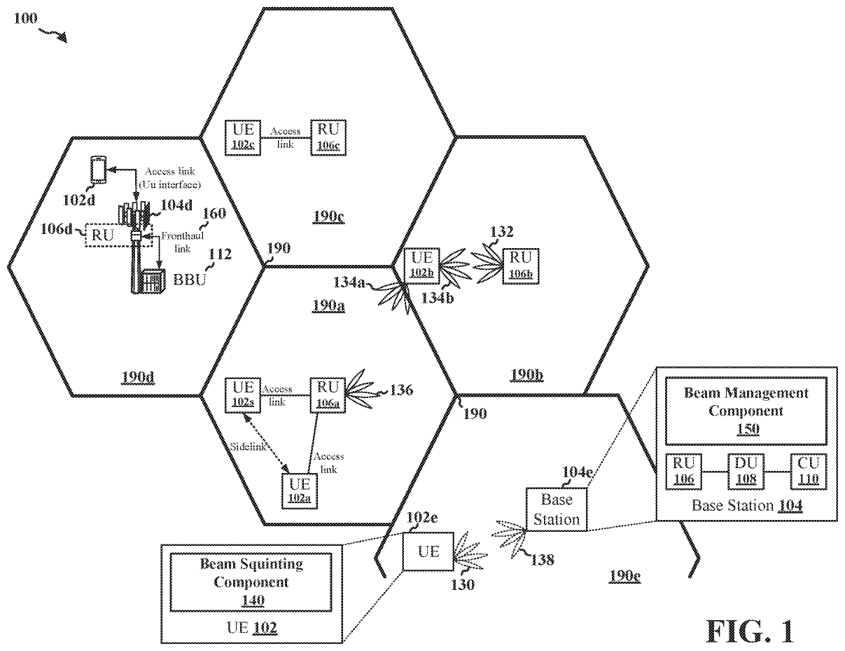

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). For example, the base stations 104d/104c and/or the RUs 106a-106d may communicate with the UEs 102a-102e and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. The CU 110 executes the aspects of the PDCP layer. The DU 108 executes the aspects of the RLC layer. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e. The UE 102e may be configured to communicate with the base station 104c via communication beams 130.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (IFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHZ, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Still referring to FIG. 1, in certain aspects, a network entity includes a beam management component 150 configured to transmit, to a first UE and a second UE, a plurality of reference signals via a plurality of beams corresponding to a plurality of subbands. The beam management component 150 is further configured to receive, from the first UE, a first indicator of a first beam of the plurality of beams and a first subband of the plurality of subbands satisfying a first threshold, and to receive, from the second UE, a second indicator of the first beam of the plurality of beams and a second subband of the plurality of subbands satisfying a second threshold. The second subband is different from the first subband. The beam management component 150 is further configured to communicate, with the first UE in a slot, a first communication via the first beam and the first subband, and to communicate, with the second UE in the same slot, a second communication via the first beam and the second subband.

In certain aspects, a UE includes a beam squinting component 140 configured to receive, from a network entity, a plurality of reference signals via a plurality of beams corresponding to a plurality of subbands. The beam squinting component 140 is further configured to transmit, to the network entity, an indicator of a first beam of the plurality of beams and a first subband of the plurality of subbands satisfying a threshold. The beam squinting component 140 is further configured to communicate, with the network entity in a slot, a first communication via the first beam and the first subband. A second communication associated with another UE is communicated in the same slot, via the first beam and a second subband of the plurality of subbands. The second subband is different from the first subband.

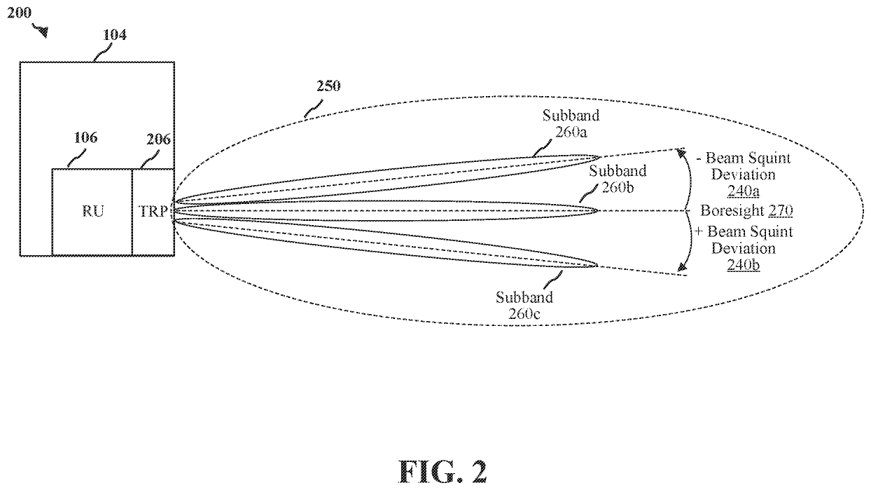

Accordingly, FIG. 1 describes a wireless communication system that may be implemented in connection with aspects of one or more other figures described herein, such as aspects illustrated in FIGS. 2-6. Further, although the following description may be focused on 5G NR, the concepts described herein may be applicable to other similar areas, such as 5G-Advanced and future versions, and other wireless technologies, such as 6G.

FIG. 2 is a diagram 200 illustrating beam squinting effect on a wideband frequency channel. In FIG. 2, the wideband frequency channel may include a plurality of subbands 260a, 260b, 260c. In some aspects, TRP 206 of network entity 104 transmits one or more beams (e.g., directional beams) 250 on the wideband frequency channel to a UE using beamforming techniques. While beamforming is used for mmWave and THz bands in order to increase a link budget, beam squinting effects of the wideband frequency channel can provide challenges for analog beamforming in directing the beam 250 to the UE. “Beam squinting,” as used herein, may refer to an unfocusing of the intended direction of the beam 250 across frequency (e.g., a wideband frequency channel) when phase shifting is used to steer the direction of the beam 250. The beam squinting effect can be caused by the frequency dependence of the magnitude of the phase shift in analog beamforming, thereby causing a beam squint deviation 240 of the arrival angle from boresight 270 (e.g., the intended direction) at the UE. Aspects of the present disclosure take advantage of the beam squinting effect by frequency division multiplexing (FDM) different UEs on the same beam 250.

In some aspects, TRP 206 transmits beam 250 over a wide bandwidth (e.g., 10 GHz, 50 GHz, 100 GHz, or larger). The wideband frequency channel of beam 250 can be partitioned into a plurality of subbands (e.g., 2, 3, 4, or more subbands). In some aspects, the subbands may be referred to as bandwidth parts, frequency bands, transmission bandwidth, and the like. In the non-limiting example of FIG. 2, the wideband frequency channel (may be referred to as component carrier, carrier bandwidth, operating bandwidth, channel bandwidth, etc.) of the beam 250 is partitioned into three subbands 260a, 260b, and 260c. In some aspects, each subband may be defined by a number of resource blocks, where each resource block includes a contiguous set of subcarriers in the frequency domain. The subband may have a configurable subcarrier spacing (e.g., 120 KHz, 240 KHz, or larger). The number of resource blocks per subband may be configured by the network entity. For example, subband 260b includes the center frequency (e.g., frequency range from 24.25 GHz to 100 GHz or higher) and has a contiguous set of subcarriers (frequency subcarriers). Subband 260b is transmitted in the intended direction (e.g., boresight 270). Subband 260a may include a bandwidth lower than subband 260b (e.g., frequency below the center frequency of subband 260b) and may be transmitted in a direction away from boresight 270 based on beam squint deviation 240a. Subband 260c may include a bandwidth higher than subband 260b (e.g., frequency above the center frequency of subband 260b) and may be transmitted in a direction away from boresight 270 based on beam squint deviation 240b. In some aspects, network entity 104 determines whether to partition beam 250 into a plurality of subbands 260 based on the frequency bandwidth (e.g., carrier bandwidth) of the beam 250. For example, network entity 104 may partition beam 250 into a plurality of subbands 260 based on the frequency bandwidth exceeding a threshold. The network entity 104 may determine how many subbands 260 to partition the beam 250 into based on the beam squinting effect on the wideband frequency channel. In some aspects, network entity 104 may determine the frequency bandwidth (e.g., continuous set of subcarriers) of each subband 260 based on the frequency bandwidth of beam 250.

Aspects of the present disclosure take advantage of the beam squinting effect by communicating with different UEs during the same time period (e.g., in the same time slot) using the same beam 250 but using different subbands 260a and 260b. For example, network entity 104 configures TRP 206 of RU 106 to transmit, to a first UE and a second UE, a plurality of reference signals via a plurality of beams including beam 250 corresponding to a plurality of subbands 260. The network entity 104 receives, from the first UE, a first indicator of beam 250 and subband 260a of the plurality of subbands satisfying a first threshold. The network entity 104 receives, from the second UE, a second indicator of beam 250 of the plurality of beams and subband 260b of the plurality of subbands satisfying a second threshold. In some implementations, the first and second thresholds may be configured by the network entity. In other implementations, the first and second thresholds may be pre-defined in a technical specification.

The network entity 104 communicates, with the first UE in a slot, a first communication via the beam 250 and the subband 260a. The network entity communicates, with the second UE in the same slot as the first UE, a second communication via beam 250 and subband 260b. For example, the network entity 104 transmits, to the first UE in a slot, a first downlink signal/channel using a network beam (beam 250) and subband 260a. The network entity 104 transmits, to the second UE in the same slot, a second downlink signal/channel using the same network beam (beam 250) and subband 260b. Although the description of FIG. 2 describes a single beam, three subbands, and two UEs communicating in the same slot using the same beam but different subbands, the present disclosure is not so limited. Aspects of the present disclosure include any number of beams, any number of subbands, and any number of UEs communicating in the same slot using the same beam but different subbands.

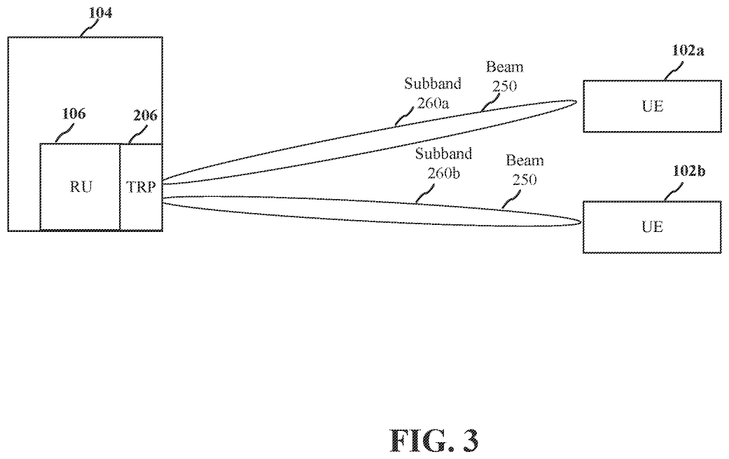

FIG. 3 is a diagram illustrating directional transmissions from a TRP 206 of network entity 104 to UEs 102a and 102b. As described above with reference to FIG. 2, TRP 206 transmits one or more beams 250 to UEs using beamforming techniques (e.g., analog beamforming). TRP 206 may include transceivers 830 and antennas 840 to implement the beam-forming techniques. In the non-limiting example of FIG. 3, network entity 104 may communicate with UEs 102a and 102b in the same slot, using the same beam 250 but with different subbands 260a and 260b.

In some aspects, network entity 104 optionally transmits a request (e.g., via radio resource control (RRC)) to UE 102a and/or UE 102b requesting a UE capability indicator to determine whether UE 102a and/or UE 102b support subband partitioning and measurement reporting. In response to the request, UE 102a and/or 102b transmit a message (e.g., via PUCCH or PUSCH) to network entity 104 indicating support for subband reporting by the UE 102a and/or 102b, respectively. In some aspects, UE 102a and/or 102b may transmit a UE capability message indicating whether UE supports subband reporting including a maximum number of subbands supported, a minimum number of subbands supported, a maximum number of beams supported, a minimum number of beams supported, and the like.

In some aspects, network entity 104 transmits a configuration (e.g., via RRC) to UE 102a and 102b indicating parameters of the subband 260 partitioning and measurement reporting. The parameters include the subband 260 frequency ranges, beam identifiers, a value of the measurement threshold, a format of the measurement reporting, etc. In some aspects, network entity 104 configures (e.g., via RRC) the UE 102a and 102b with a set of transmission configuration indicators (TCIs) (e.g., up to 128 TCIs) that map identifiers of each beam (e.g., beam index) to identifiers of the subbands (e.g., subband indexes). Each TCI may also include quasi-co-location relationships (e.g., Doppler shift, Doppler spread, average delay, delay spread, spatial receive parameter) between reference signals and channels. The network entity 104 transmits a first set of TCIs (e.g., a first TCI, a second TCI, a third TCI, etc.) to the UE 102a that maps an identifier of the beam(s) to an identifier of the subband(s). The network entity 104 transmits a second set of TCIs to the UE 102b that maps an identifier of the beam(s) to an identifier of the subband(s). The number of TCIs in the first set of TCIs and the second set of TCIs may depend on the number of beams and the number of subbands configured by the network entity 104. In some aspects, the network entity 104 may configure a set of TCIs via RRC, and may activate a subset of TCIs from the set of configured TCIs via MAC CE and/or DCI. In the example shown in FIG. 3, network entity 104 may transmit DCI to the UE 102a activating beam 250 and subband 260a. Network entity 104 may transmit DCI to the UE 102b activating beam 250 and subband 260b.

In some aspects, network entity 104 partitions the wideband frequency channel into multiple subbands (e.g., 2, 3, 4, or more subbands). In the non-limiting example, of FIG. 3, network entity 104 partitions the wideband frequency channel into subbands 260a and 260b. The network entity 104 transmits reference signals (e.g., CSI-RSs, PTRSs, SSBs, and/or other suitable reference signals) over a plurality of beams including beam 250 to UEs 102a and 102b. The number of beams can be based on a configuration of TRP 206. Accordingly, network entity 104 transmits the reference signals via beam 250 using a wideband frequency channel partitioned into subbands 260a and 260b.

In some aspects, UE 102a and 102b may perform a beam sweeping procedure to determine an optimal UE receive beam for receiving the reference signals. In some aspects, UE 102a and 102b measure the reference signals across subbands 260a and 260b. For example, UE 102a and 102b measure RSRP, RSSI, and/or SINR of the reference signals. In some aspects, UE 102a and 102b may compare the measurements to a threshold and report to the network entity 104 identifiers of the beam/subband combinations satisfying the threshold. In some aspects, the beam identifier (e.g., beam index) may correspond to an index of the associated reference signal. In other words, beam1 may correspond to reference signal index1 (e.g., reference signal transmitted on beam1), beam2 may correspond to reference signal index2 (e.g., reference signal transmitted on beam2), and so forth. Accordingly, the UE 102a and 102b may report the reference signal index to indicate the beam/subband combinations satisfying the threshold. In some aspects, UE 102a and 102b may compare the measurements to the same threshold or a different threshold. UE 102a and 102b may determine whether the measurements are greater than or equal to the threshold(s). Additionally or alternatively, UE 102a and 102b may report the values of the measurements to the network entity 104. For example, UE 102a and 102b may report the highest RSRP, SINR, and/or RSSI of a measured beam 250/subband 260 combination. The UE 102a and 102b may additionally report measurements of other measured beam(s)/subband(s) (e.g., a subset of the next highest measurement(s)). The additional measurements may be reported as a delta from the highest reported measurements. In some aspects, the UE 102a and 102b may transmit the measurements in a channel state information (CSI) report to the network entity 104 via a PUCCH communication, a PUSCH communication, and/or other suitable communication. The UE 102a and 102b transmit the measurements to network entity 104 periodically, aperiodically, and/or semi-persistently.

After receiving the measurement reports, network entity 104 transmits to UE 102a and 102b (e.g., via DCI on a PDCCH) a schedule for downlink communications (e.g., a dynamic downlink assignment or semi-persistent scheduling) that indicates resources for PDSCHs. The resources may indicate a beam 250 identifier (e.g., beam index or reference signal index), a subband 260 identifier (e.g., subband index), and a time slot identifier (e.g., slot index or symbol index) for the scheduled PDSCHs.

After transmitting the downlink communication schedule, network entity 104 transmits downlink communications to UE 102a and 102b using the same beam 250 in the same time slot but using different subbands 260. For example, network entity 104 transmits downlink communications to UE 102a using the same beam 250 in the same time slot but using subband 260a. Network entity 104 transmits downlink communications to UE 102b using the same beam 250 in the same time slot but using a different subband 260b. By taking advantage of the deviation from boresight direction due to frequency dependent beam squinting, spectral efficiency and throughput of the network is increased.

In some aspects, the downlink channel can have reciprocity with the uplink channel. In this case, the uplink channel can also take advantage due to frequency dependent beam squinting. In this regard, network entity 104 transmits a schedule (e.g., an uplink grant) to UE 102a and 102b indicating uplink resources comprising a time slot (e.g., slot index or symbol index), beam 250 identifier (e.g., beam index or reference signal index), and a subband 260 identifier (e.g., subband index). Accordingly, UE 102a and 102b may be scheduled in the same time slot and with the same beam 250 identifier but using different subbands 260a and 260b, respectively. For example, UE 102a transmits uplink communications using the same beam 250 in the same time slot but using subband 260a. UE 102b transmits uplink communications using the same beam 250 in the same time slot but using a different subband 260b.

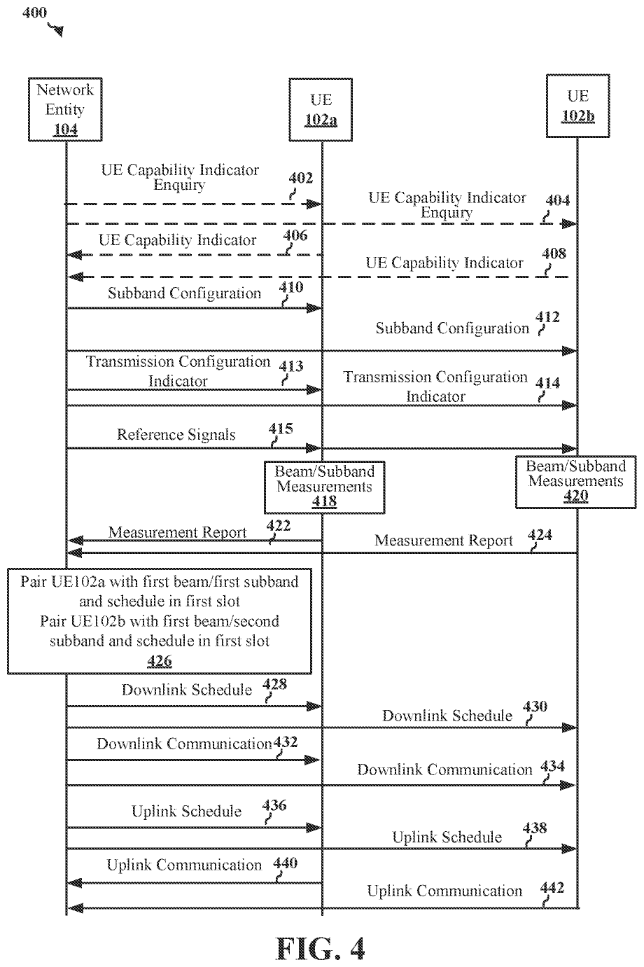

FIG. 4 is a signal flow diagram of a communication method 400 according to some aspects of the present disclosure. Aspects of the method 400 can be executed by a computing device (e.g., a processor, processing circuit, and/or other suitable component) of a wireless communication device or other suitable means for performing the actions. For example, a wireless communication device, such as the UE 102 or the UE 702 utilizes one or more components, such as the application processor 706, the memory 706′, the beam squinting component 140a and/or 140b, the transceiver 730, the wireless baseband processor 726, the memory 726′, and the one or more antennas 740, to execute aspects of method 400. In some aspects, a wireless communication device, such as the network entity 104 utilizes one or more components, such as the DU processor 826, the memory 826′, the CU processor 846, the memory 846′, the RU processor 806, the memory 806′, the beam management reporting component 150a/150b, and/or 150c, the transceiver 830, and the one or more antennas 840, to execute aspects of method 400. The method 400 employs similar mechanisms as in the network 100 and the aspects and actions described with respect to FIGS. 2 and 3. As illustrated, the method 400 includes a number of enumerated actions, but the method 400 can include additional actions before, after, and in between the enumerated actions. In some aspects, one or more of the enumerated actions can be omitted or performed in a different order.

The UE 102a may optionally receive 402 a UE capability indicator enquiry from the network entity 104. In this regard, the UE 102a may optionally receive 402 a UE capability indicator enquiry via radio resource control (RRC) signaling or other suitable communication. The UE capability indicator enquiry is a request for the UE 102a to report its capability associated with subband partitioning and measurement reporting to network entity 104.

The UE 102a optionally transmits 406 a UE capability indicator to network entity 104. In this regard, UE 102a transmits 406 the UE capability indicator to network entity 104 using a PUCCH communication or other suitable communication. The UE 102a transmits 406 the UE capability indicator to the network entity 104 autonomously or in response to receiving 402 the UE capability indicator enquiry. The UE capability indicator indicates the UE's 102a capability associated with subband partitioning and measurement reporting to the network entity 104. Additionally or alternatively, the UE's 102a capability may be prestored in UE 102a and network entity 104.

The UE 102b may optionally receive 404 a UE capability indicator enquiry from the network entity 104. In this regard, the UE 102b may optionally receive 404 a UE capability indicator enquiry from the network entity 104 using radio resource control (RRC) signaling or other suitable communication. The UE capability indicator enquiry is a request for the UE 102b to report its capability associated with subband partitioning and measurement reporting to the network entity 104.

The UE 102b optionally transmits 408 a UE capability indicator to the network entity 104. In this regard, the UE 102b transmits 408 the UE capability indicator to network entity 104 using a PUCCH communication or other suitable communication. The UE 102b transmits 408 the UE capability indicator to the network entity 104 autonomously or in response to receiving 404 the UE capability indicator enquiry. The UE capability indicator indicates the UE's 102b capability associated with subband partitioning and measurement reporting to the network entity 104. Additionally or alternatively, the UE's 102b capability may be prestored in UE 102b and network entity 104.

The network entity 104 transmits 410 a subband configuration (e.g., via RRC) to UE 102a indicating parameters of the subband partitioning and measurement reporting. In some aspects, the subband configuration may be part of a CSI report configuration or other reporting configuration. The parameters may include the number of subbands, subband identifiers (e.g., subband indexes), subband frequency ranges (e.g., set of contiguous subcarriers), a value of the measurement threshold (e.g., dB), number of beams, beam identifiers (e.g., beam indexes), format of the measurement reporting, and/or other suitable parameters. In some aspects, the network entity 104 may transmit a reference signal configuration as part of the CSI report configuration for subband reporting. The reference signal configuration may indicate parameters for the reference signal transmission such as reference signal identifier (e.g., reference signal index), resource set, transmission power, antenna ports, time-domain behavior (e.g., periodic, aperiodic, semi-persistent), and the like.

The network entity 104 transmits 412 a subband configuration (e.g., via RRC) to UE 102b indicating parameters of the subband partitioning and measurement reporting. In some aspects, the subband configuration may be part of a CSI report configuration or other reporting configuration. The parameters may include the number of subbands, subband identifiers (e.g., subband indexes), subband frequency ranges (e.g., set of contiguous subcarriers), a value of the measurement threshold (e.g., dB), number of beams, beam identifiers (e.g., beam indexes), format of the measurement reporting, and/or other suitable parameters. In some aspects, the network entity 104 may transmit a reference signal configuration as part of the CSI report configuration for subband reporting. The reference signal configuration may indicate parameters for the reference signal transmission such as reference signal identifier (e.g., reference signal index), resource set, transmission power, antenna ports, time-domain behavior (e.g., periodic, aperiodic, semi-persistent), and the like.

The network entity 104 configures (e.g., via RRC) the UE 102a and 102b with a set of TCIs (e.g., up to 128 TCIs) that map identifiers of each beam (e.g., beam index) to identifiers of the subbands (e.g., subband indexes). The network entity 104 transmits 413 a first set of TCIs (e.g., a first TCI, a second TCI, a third TCI, etc.) to the UE 102a that maps an identifier of the beam(s) to an identifier of the subband(s). For example, the first TCI maps beam index1 to subband index1, the second TCI maps beam index1 to subband index2, the third TCI maps beam index2 to subband index1, etc. The network entity 104 transmits 413 a second set of TCIs (e.g., a first TCI, a second TCI, a third TCI, etc.) to the UE 102b that maps an identifier of the beam(s) to an identifier of the subband(s). For example, the first TCI maps beam index1 to subband index2, the second TCI maps beam index1 to subband index1, the third TCI maps beam index2 to subband index2, etc. The number of TCIs in the first set of TCIs and the second set of TCIs may depend on the number of beams and the number of subbands configured by the network entity 104. In some aspects, the network entity 104 may configure a set of TCIs via RRC, and may activate or indicate a subset of TCIs from the set of configured TCIs via MAC CE and/or DCI. In some aspects, each configured TCI can be associated with downlink TCI state, uplink TCI state, or joint TCI state. Downlink TCI state is associated with transmission parameters for downlink channels. Uplink TCI state is associated with transmission parameters for uplink channels. Joint TCI state is associated with transmission parameters for both downlink and uplink channels.

In some aspects, network entity 104 partitions the wideband frequency channel into multiple subbands (e.g., 2, 3, 4, or more subbands). The network entity 104 transmits 415 reference signals (e.g., CSI-RSs, PTRSs, SSBs, and/or other suitable reference signals) over a plurality of beams to UEs 102a and 102b. For example, at time T1, the network entity 104 transmits the reference signal (e.g., CSI-RS1, PTRS1, or SSB1) on a transmit beam1 (e.g., beam index1). At time T2, the network entity 104 transmits the reference signal (e.g., CSI-RS2, PTRS2, or SSB2) on a transmit beam2 (e.g., beam index2), and so forth. The number of beams, the number of subbands, reference signal type, periodicity, number of repetitions, etc. can be based on a configuration of a TRP and may be configured by the network entity 104. Accordingly, network entity 104 transmits the reference signals via beams using a wideband frequency channel partitioned into subbands. Network entity 104 may transmit 415 the reference signals to UE 102a and 102b in common resources. In some aspects, the network entity 104 may broadcast the reference signals for a cell. In some other aspects, the network entity 104 may multicast the reference signals to a group of UEs. Additionally or alternatively, network entity 104 may transmit the reference signals to UE 102a in resources dedicated to UE 102a and may transmit the reference signals to UE 102b in resources dedicated to UE 102b. In some aspects, the network entity 104 may transmit a control signal to trigger transmission of the reference signal.

The UE 102a measures 418 the reference signals transmitted 415 by network entity 104 across subbands indicated in the subband configuration. In some aspects, the UE may perform a beam sweeping procedure to find the best UE receive beam for receiving the reference signals. For example, the UE may cycle through a set of UE receive beams for receiving the reference signals and determine the UE receive beam that can receive the reference signals with the best quality. For example, UE 102a measures RSRP, RSSI, and/or SINR of the reference signals. In some aspects, UE 102a compares the measurement(s) to a threshold. The UE 102a may determine whether the measurements are greater than or equal to the threshold.

The UE 102b measures 420 the reference signals transmitted 415 by network entity 104 across subbands indicated in the subband configuration. For example, UE 102b measures RSRP, RSSI, and/or SINR of the reference signals. In some aspects, UE 102b compares the measurement(s) to a threshold. The UE 102b may determine whether the measurements are greater than or equal to the threshold. In some aspects, UE 102a and 102b may compare the measurements to the same threshold or a different threshold.

The UE 102a transmits 422 a measurement report to network entity 104. The measurement report is in accordance with the reporting configuration and includes identifiers of the beam/subband combinations satisfying the threshold. For example, the UE 102a transmits 422 a measurement report indicating a best beam/subband combination including the beam 250 and subband 260a. Additionally or alternatively, the measurement report includes values of the measurements. For example, UE 102a reports the highest RSRP, SINR, and/or RSSI of a measured beam/subband combination. The UE 102a may additionally report measurements of other measured beam(s)/subband(s) (e.g., a subset of the next highest measurement(s)). The additional measurements may be reported as a delta from the highest reported measurements. In some aspects, the UE 102a transmits 422 the measurements in a CSI report to the network entity 104 via a PUCCH communication, a PUSCH, and/or other suitable communication. The UE 102a transmits 422 the measurements to network entity 104 periodically, aperiodically, or semi-persistently. For aperiodic or semi-persistent reporting, the network entity 104 may transmit control signaling to trigger the measurement report.

The UE 102b transmits 424 a measurement report to network entity 104. The measurement report includes identifiers of the beam/subband combinations satisfying the threshold. For example, the UE 102b transmits 424 a measurement report indicating a best beam/subband combination including the beam 250 and subband 260b. Additionally or alternatively, the measurement report includes values of the measurements. For example, UE 102b reports the highest RSRP, SINR, and/or RSSI of a measured beam/subband combination. The UE 102b may additionally report measurements of other measured beam(s)/subband(s) (e.g., a subset of the next highest measurement(s)). The additional measurements may be reported as a delta from the highest reported measurements. In some aspects, the UE 102b transmits 424 the measurements in a CSI report to the network entity 104 via a PUCCH, a PUSCH, and/or other suitable communication. The UE 102b transmits 424 the measurements to network entity 104 periodically, aperiodically, semi-persistently.

The network entity 104 pairs 426 UEs 102a and 102b based on the measurement reports from UE 102a and 102b, respectively. Accordingly, the network entity 104 may pair the UEs 102a and 102b for multi-user scheduling that takes advantage of beam squinting effect for wideband frequency channels.

The network entity 104 schedules the UE 102a with a beam/subband combination based on the measurement report received 422 from the UE 102a. In some aspects, the network entity 104 schedules the UE 102a with a beam/subband combination having the highest signal quality indicated in the measurement report received 422 from UE 102a. In some other aspects, the network entity 104 schedules the UE 102a with a beam/subband combination having a signal quality satisfying a threshold as indicated in the measurement report received 422 from UE 102a.

The network entity 104 schedules the UE 102b with a beam/subband combination based on the measurement report received 424 from the UE 102b. In some aspects, the network entity 104 schedules the UE 102b with a beam/subband combination having the highest signal quality indicated in the measurement report received 424 from UE 102b. In some other aspects, the network entity 104 schedules the UE 102b with a beam/subband combination having a signal quality satisfying a threshold as indicated in the measurement report received 424 from UE 102b. For example, the network entity 104 schedules the UE 102b with the first beam (e.g., the same beam as the UE 102a) and a second subband (e.g., a different subband from the UE 102a).

In some aspects, the network entity 104 communicates with the UE 102a in a first slot via the first beam and the first subband and communicates with the UE 102b in the same first slot via the first beam and the second subband. At a later time, the network entity 104 may decide to pair the UE 102a with another UE (different from the UE 102b) based on subsequent measurement reports from the UEs. Accordingly, the network entity 104 may schedule a communication with the UE 102a in a second slot (e.g., different from the first slot) via the first beam and the first subband and a communication with another UE (e.g., different from the 102b) in the second slot via the first beam and the second subband.

After pairing 426 the UEs 102a and 102b based on the measurement report, the network entity 104 transmits 428 (e.g., via DCI on a PDCCH) a schedule to the UE 102a for downlink communications (e.g., a dynamic downlink assignment or semi-persistent scheduling). The downlink schedule indicates time/frequency/spatial resources in which the network entity transmits PDSCH communications to the UE 102a. The downlink schedule indicates a beam identifier (e.g., beam index), a first subband identifier (e.g., subband index), and a time slot identifier (e.g., slot index or symbol index) for the scheduled PDSCHs. For example, the DCI may indicate a TCI state (among the configured TCIs) as well as other parameters for the scheduled PDSCH. Accordingly, the UE 102a may determine the beam and subband associated with the scheduled PDSCH based on the TCI state.

Additionally, the network entity 104 transmits 430 (e.g., via DCI on a PDCCH) a schedule to the UE 102b for downlink communications (e.g., a dynamic downlink assignment or semi-persistent scheduling). The downlink schedule indicates time/frequency/spatial resources in which the network entity transmits PDSCH communications to the UE 102b. The downlink schedule indicates the beam identifier (e.g., beam index), a second subband identifier (e.g., subband index), and the time slot identifier (e.g., slot index or symbol index) for the scheduled PDSCHs. For example, the DCI may indicate a TCI state (among the configured set of TCIs) as well as other parameters for the scheduled PDSCH. Accordingly, the UE 102b may determine the beam and subband associated with the scheduled PDSCH based on the TCI state.

After transmitting 428 the downlink communication schedule to the UE 102a and UE 102b, network entity 104 transmits 432, 434 downlink communications (e.g., scheduled PDSCHs) to UE 102a and UE 102b, respectively, in the same time slot, using the same beam but using different subbands. UE 102a receives 432 downlink communications in the first subband while UE 102b receives 434 downlink communications in the second subband. Although illustrated as separate arrows for 432 and 434, it is noted that the downlink transmissions to the UEs 102a and 102b are performed at the same time (e.g., in the same time slot) by the network entity. By taking advantage of the beam deviation from boresight direction due to frequency dependent beam squinting, spectral efficiency and downlink throughput of the network is increased.

After pairing 426 the UEs 102a and 102b based on the measurement report, the network entity 104 transmits 436 (e.g., via DCI on a PDCCH) a schedule to the UE 102a for uplink communications (e.g., a dynamic uplink grant, configured uplink grant, or semi-persistent scheduling). The uplink schedule indicates time/frequency/spatial resources in which the UE 102a transmits uplink communications to the network entity 104. The uplink schedule indicates a beam identifier (e.g., beam index), a first subband identifier (e.g., subband index), and a time slot identifier (e.g., slot index or symbol index) for the scheduled PUCCH or PUSCH. For example, the DCI may indicate a TCI state (among the configured TCIs) as well as other parameters for the scheduled PUCCH or PUSCH. Accordingly, the UE 102a transmit the PUCCH or PUSCH using the beam and subband based on the TCI state.

Additionally, the network entity 104 transmits 438 (e.g., via DCI on a PDCCH) a schedule to the UE 102b for uplink communications (e.g., a dynamic schedule, configured grant, or semi-persistent schedule). The uplink schedule indicates time/frequency/spatial resources in which the UE 102b transmits PUCCH or PUSCH communications to the network entity 104. The uplink schedule indicates the beam identifier (e.g., beam index), a second subband identifier (e.g., subband index), and the time slot identifier (e.g., slot index or symbol index) for the scheduled PUCCH or PUSCH. For example, the DCI may indicate a TCI state (among the configured TCIs) as well as other parameters for the scheduled PUCCH or PUSCH. Accordingly, the UE 102b transmit the PUCCH or PUSCH using the beam and subband based on the TCI state.

In some aspects, the downlink channel characteristics may have reciprocity with the uplink channel characteristics. In this case, the uplink channel can also benefit from frequency dependent beam squinting. Uplink communications transmitted by UE 102a and 102b can be scheduled in the same time slot and using the same beam identifier but using different subbands. After transmitting 436, 438 the uplink communication schedules to the UE 102a and UE 102b, network entity 104 receives 440, 442 uplink communications (e.g., scheduled PUCCHs or PUSCHs) from UE 102a and UE 102b, respectively, in the same time slot, using the same beam but using different subbands. UE 102a transmits uplink communications in the first subband while the UE 102b transmits uplink communications in the second subband. Although illustrated as separate arrows for 440 and 442, it is noted that the uplink transmissions are performed by the UEs 102a and 102b, respectively, at substantially the same time (e.g., in the same time slot). By taking advantage of the beam deviation from boresight direction due to frequency dependent beam squinting, spectral efficiency and uplink throughput of the network is increased.

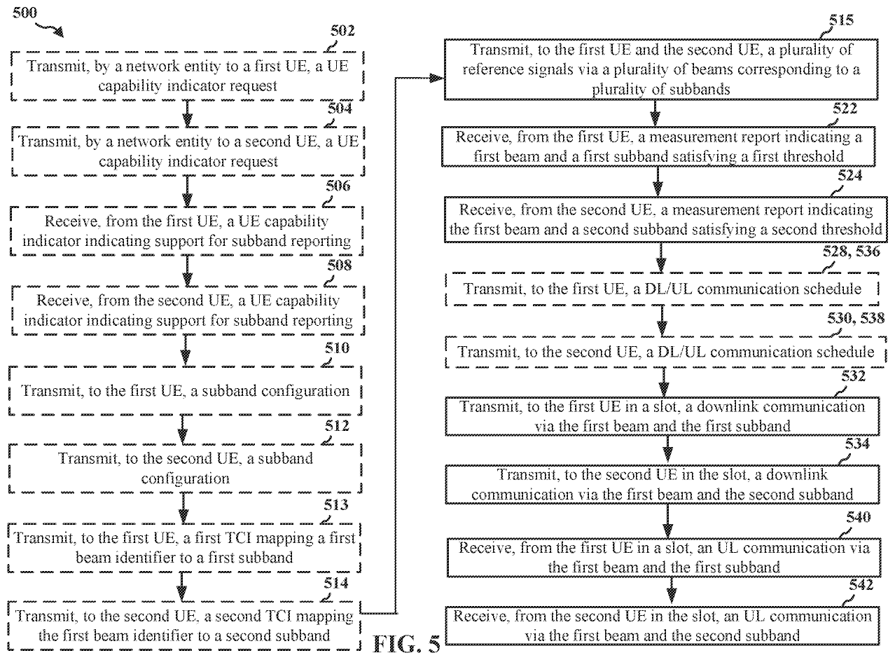

FIG. 5 illustrates a flowchart 500 of a method of wireless communication at a network entity (e.g., network entity 104), the RU 106, the DU 108, the CU 110, etc., which includes the beam management components 150a/150b/150c, memory 806′, 826′, 846′, and which may correspond to the entire network entity 104, or a component of the network entity 104, such as the RU processor 806, DU processor 826 and/or the CU processor 846.

The network entity transmits 502, a UE capability indicator request to a first UE. For example, referring to FIG. 4, network entity 104 transmits 402, a UE capability indicator enquiry to the UE 102a.

The network entity transmits 504, a UE capability indicator request to a second UE. For example, referring to FIG. 4, network entity 104 transmits 404, a UE capability indicator enquiry to the UE 102b.

The network entity receives 506, a UE capability indicator indicating support for subband reporting from the first UE. For example, referring to FIG. 4, network entity 104 receives 406, a UE capability indicator indicating support for subband reporting from the UE 102a.

The network entity receives 508, a UE capability indicator indicating support for subband reporting from the second UE. For example, referring to FIG. 4, the network entity 104 receives 408, a UE capability indicator indicating support for subband reporting from the UE 102b.

The network entity transmits 510, a subband configuration to the first UE. For example, referring to FIG. 4, network entity 104 transmits 410, a subband configuration to the UE 102a.

The network entity transmits 512, a subband configuration to the second UE. For example, referring to FIG. 4, network entity 104 transmits 412, a subband configuration to the UE 102b.

The network entity transmits 513, to the first UE, a set of TCIs (e.g., up to 128 TCIs) that map identifiers of each beam (e.g., beam index) to identifiers of the subbands (e.g., subband indexes). In some aspects, the network entity transmits DCI that indicates a TCI associated with first beam and a first subband for the scheduled transmission. For example, referring to FIG. 4, network entity 104 transmits 413, to the UE 102a, a set of TCIs that map identifiers of each beam (e.g., beam index) to identifiers of the subbands (e.g., subband indexes). The network entity transmits first DCI that indicates a first beam identifier and a first subband for a scheduled transmission in a slot.

The network entity transmits 514, to the second UE, a set of TCIs that map identifiers of each beam (e.g., beam index) to identifiers of the subbands (e.g., subband indexes). In some aspects, the network entity transmits second DCI that indicates a TCI associated with the first beam identifier and a second subband. For example, referring to FIG. 4, network entity 104 transmits 414, to the UE 102a, a set of TCIs that map identifiers of each beam (e.g., beam index) to identifiers of the subbands (e.g., subband indexes). The network entity transmits second DCI that indicates a first beam identifier and a second subband for a scheduled transmission in the same slot.

The network entity transmits 515, to the first UE and the second UE, a plurality of reference signals via a plurality of beams corresponding to a plurality of subbands. For example, referring to FIG. 4, network entity 104 transmits 415, to the UE 102a and the UE 102b, a plurality of reference signals via a plurality of beams corresponding to a plurality of subbands.

The network entity receives 522, from the first UE, a measurement report indicating a first beam and a first subband satisfying a first threshold. For example, referring to FIG. 4, the network entity 104 receives 422, from the UE 102a, a measurement report indicating a first beam and a first subband satisfying a first threshold.

The network entity receives 524, a measurement report, from the second UE, indicating a first beam and a second subband satisfying a second threshold. For example, referring to FIG. 4, the network entity 104 receives 424, from the UE 102b, a measurement report indicating the first beam and a second subband satisfying a second threshold.

In some aspects, the network entity transmits a communication schedule to the first UE for scheduling downlink or uplink communications. In one example, the network entity transmits 528, a downlink communication schedule to the first UE. For example, referring to FIG. 4, the network entity 104 transmits 428, a downlink communication schedule to the UE 102a. In another example, the network entity transmits 536, an uplink communication schedule to the first UE. For example, referring to FIG. 4, the network entity 104 transmits 436, an uplink communication schedule to the UE 102a.

In some other aspects, the network entity transmits a communication schedule to the second UE for scheduling downlink or uplink communications. In one example, the network entity transmits 530, a downlink communication schedule to the second UE. For example, referring to FIG. 4, the network entity 104 transmits 430, a downlink communication schedule to the UE 102b. In another example, the network entity transmits 538, an uplink communication schedule to the second UE. For example, referring to FIG. 4, the network entity 104 transmits 438, an uplink communication schedule to the UE 102b.

In some aspects, the network entity communicates, with the first UE in a slot, a first communication via the first beam and the first subband. In one example, the network entity transmits 532, to the first UE in a slot, a downlink communication via the first beam and the first subband. For example, referring to FIG. 4, the network entity 104 transmits 432, to the UE 102a in a slot, a downlink communication via the first beam and the first subband. In another example, the network entity receives 540, from the first UE in a slot, an uplink communication via the first beam and the first subband. For example, referring to FIG. 4, the network entity 104 receives 440, from the UE 102a in a slot, an uplink communication via the first beam and the first subband.

In some other aspects, the network entity communicates, with the second UE in the slot, a second communication via the first beam and the second subband. In one example, the network entity transmits 534, to the second UE in the same slot, a downlink communication via the first beam and the second subband. For example, referring to FIG. 4, the network entity 104 transmits 434, to the UE 102b in the slot, a downlink communication via the first beam and the second subband. In another example, the network entity receives 542, from the second UE in the same slot, an uplink communication via the first beam and the second subband. For example, referring to FIG. 4, the network entity 104 receives 442, from the UE 102b in the slot, an uplink communication via the first beam and the second subband.

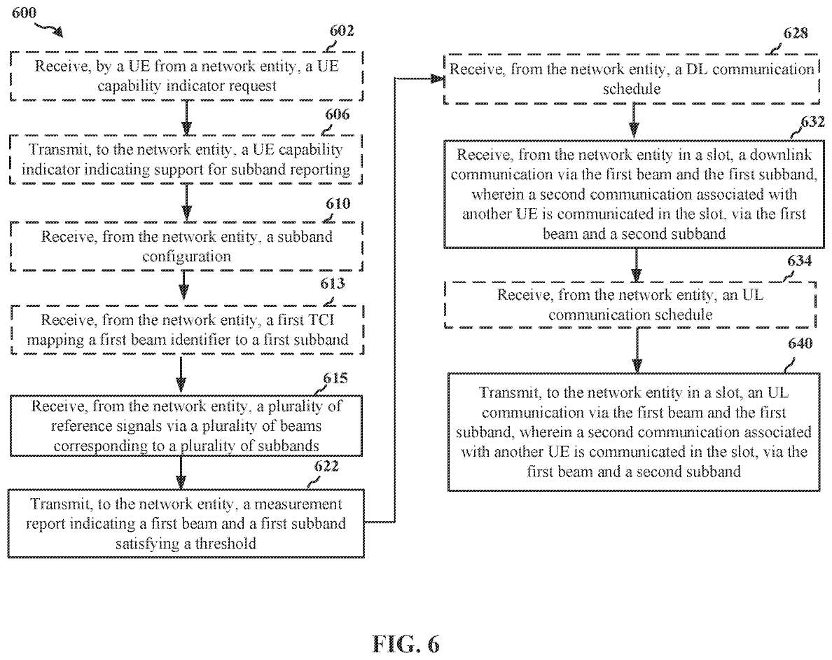

FIG. 6 illustrates a flowchart 600 of a method of wireless communication at a UE (e.g., UE 102, UE 702) includes the beam squinting components 140a/140b, memory 706′, 726′, 746′, and which may correspond to the entire UE 702.

The UE receives 602, a UE capability indicator request from a network entity. For example, referring to FIG. 4, UE 102a receives 402, a UE capability indicator request from network entity 104.

The UE transmits 606, a UE capability indicator indicating support for subband reporting to the network entity. For example, referring to FIG. 4, UE 102a transmits 404 a UE capability indicator indicating support for subband reporting to the network entity 104.

The UE receives 610, a subband configuration from the network entity. For example, referring to FIG. 4, UE 102a receives 410, a subband configuration from network entity 104.

The UE receives 613, from the network entity, a set of TCIs that map identifiers of each beam (e.g., beam index) to identifiers of the subbands (e.g., subband indexes). In some aspects, the UE receives DCI that indicates a TCI associated with a first beam identifier and a first subband. For example, referring to FIG. 4, UE 102a receives 413, from network entity 104, a set of TCIs that map identifiers of each beam (e.g., beam index) to identifiers of the subbands (e.g., subband indexes). The UE receives DCI that activates a first beam identifier to a first subband.

The UE receives 615, from the network entity, a plurality of reference signals via a plurality of beams corresponding to a plurality of subbands. For example, referring to FIG. 4, UE 102a receives 415, from network entity 104, a plurality of reference signals via a plurality of beams corresponding to a plurality of subbands.

The UE transmits 622, a measurement report indicating a first beam and a first subband satisfying a first threshold to the network entity. For example, referring to FIG.

4, the UE 102a transmits 422, a measurement report indicating a first beam and a first subband satisfying a first threshold to network entity 104.

The UE receives 628, a downlink communication schedule from the network entity. For example, referring to FIG. 4, the UE 102a receives 428, a downlink communication schedule from the network entity 104.

The UE receives 632, from the network entity in a slot, a downlink communication via the first beam and the first subband, where a second downlink communication associated with another UE is communicated in the slot, via the first beam and a second subband. For example, referring to FIG. 4, the UE 102a receives 432, from the network entity 104 in a slot, a downlink communication via the first beam and the first subband. In the same slot, a second downlink communication associated with another UE is communicated (e.g., at 434 in FIG. 4) via the first beam and a second subband.

The UE receives 634, an uplink communication schedule from the network entity. For example, referring to FIG. 4, the UE 102a receives 434, an uplink communication schedule from the network entity 104.

The UE transmits 640, to the network entity in a slot, an uplink communication via the first beam and the first subband, where a second uplink communication associated with another UE is communicated in the slot, via the first beam and a second subband. For example, referring to FIG. 4, the UE 102a transmits 440, to the network entity 104 in a slot, an uplink communication via the first beam and the first subband. In the same slot, a second uplink communication associated with another UE is communicated (e.g., at 442 in FIG. 4) via the first beam and a second subband.

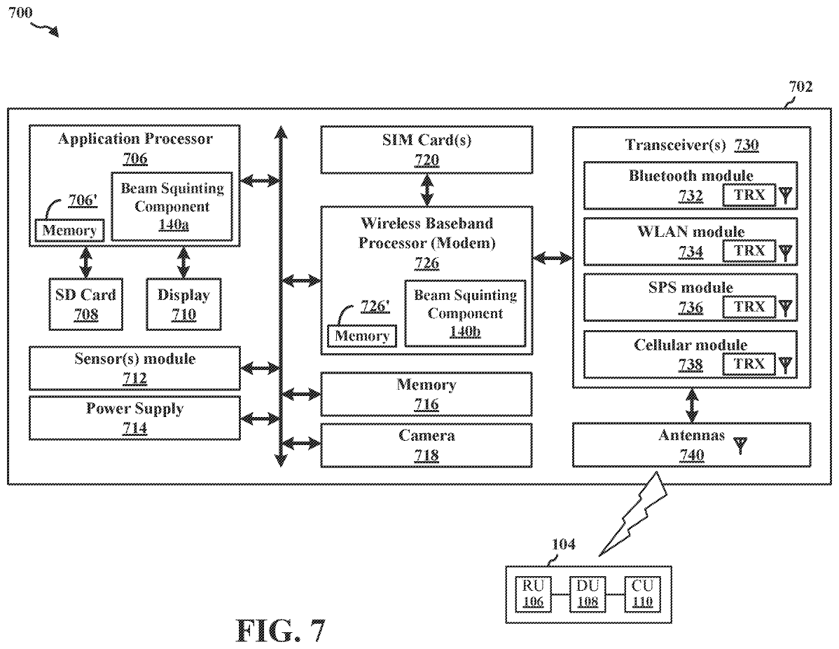

FIG. 7 is a diagram 700 illustrating an example of a hardware implementation for a UE apparatus 702. The UE apparatus 702 may be the UE 102, a component of the UE 102, or may implement UE functionality. The UE apparatus 702 may include an application processor 706, which may have on-chip memory 706′. In examples, the application processor 706 may be coupled to a secure digital (SD) card 708 and/or a display 710. The application processor 706 may also be coupled to a sensor(s) module 712, a power supply 714, an additional module of memory 716, a camera 718, and/or other related components. For example, the sensor(s) module 712 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 702 may further include a wireless baseband processor 726, which may be referred to as a modem. The wireless baseband processor 726 may have on-chip memory 726′. Along with, and similar to, the application processor 706, the wireless baseband processor 726 may also be coupled to the sensor(s) module 712, the power supply 714, the additional module of memory 716, the camera 718, and/or other related components. The wireless baseband processor 726 may be additionally coupled to one or more subscriber identity module (SIM) card(s) 720 and/or one or more transceivers 730 (e.g., wireless RF transceivers).

Within the one or more transceivers 730, the UE apparatus 702 may include a Bluetooth module 732, a WLAN module 734, an SPS module 736 (e.g., GNSS module), and/or a cellular module 738. The Bluetooth module 732, the WLAN module 734, the SPS module 736, and the cellular module 738 may each include an on-chip transceiver (TRX), or in some cases, just a transmitter (TX) or just a receiver (RX). The Bluetooth module 732, the WLAN module 734, the SPS module 736, and the cellular module 738 may each include dedicated antennas and/or utilize antennas 740 for communication with one or more other nodes. For example, the UE apparatus 702 can communicate through the transceiver(s) 730 via the antennas 740 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 726 and the application processor 706 may each include a computer-readable medium/memory 726′, 706′, respectively. The additional module of memory 716 may also be considered a computer-readable medium/memory. Each computer-readable medium/memory 726′, 706′, 716 may be non-transitory. The wireless baseband processor 726 and the application processor 706 may each be responsible for general processing, including execution of software stored on the computer-readable medium/memory 726′, 706′, 716. The software, when executed by the wireless baseband processor 726/application processor 706, causes the wireless baseband processor 726/application processor 706 to perform the various functions described herein. The computer-readable medium/memory may also be used for storing data that is manipulated by the wireless baseband processor 726/application processor 706 when executing the software. The wireless baseband processor 726/application processor 706 may be a component of the UE 102. The UE apparatus 702 may be a processor chip (e.g., modem and/or application) and include just the wireless baseband processor 726 and/or the application processor 706. In other examples, the UE apparatus 702 may be the entire UE 102 and include the additional modules of the apparatus 702.

As discussed in FIG. 1 and implemented with respect to FIG. 6, the beam squinting component 140 is configured to receive, from a network entity, a plurality of reference signals via a plurality of beams corresponding to a plurality of subbands. The beam squinting component 140 is further configured to transmit, to the network entity, an indicator of a first beam of the plurality of beams and a first subband of the plurality of subbands satisfying a threshold. The beam squinting component 140 is further configured to communicate, with the network entity in a slot, a first communication via the first beam and the first subband, where a second communication associated with another UE is communicated in the slot, via the first beam and a second subband of the plurality of subbands, the second subband being different from the first subband.

The beam squinting component 140 may be within the application processor 706 (e.g., at 140a), the wireless baseband processor 726 (e.g., at 140b), or both the application processor 706 and the wireless baseband processor 726. The beam squinting component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

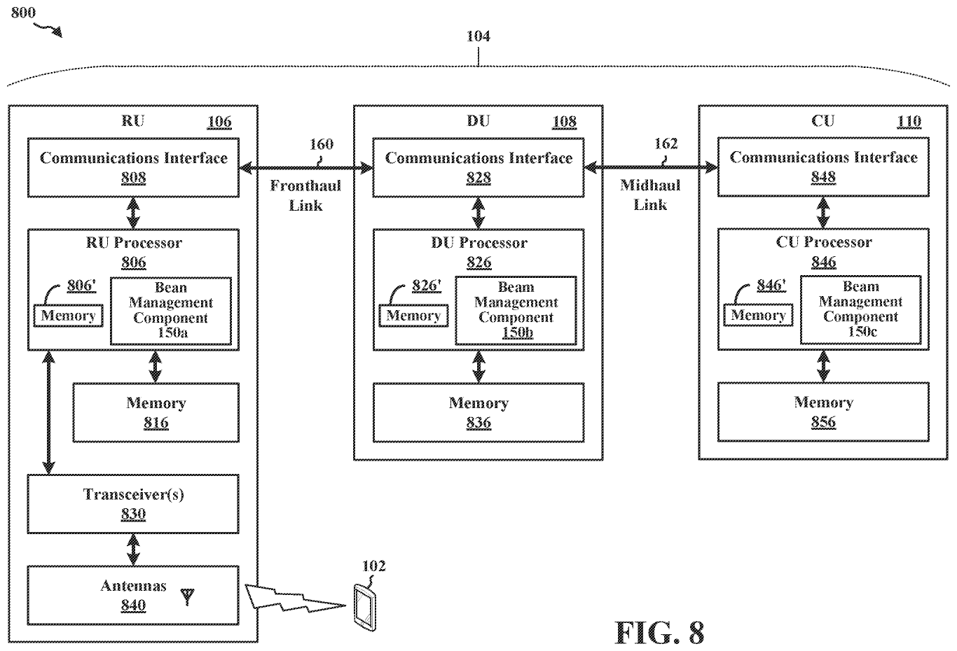

FIG. 8 is a diagram 800 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 846, which may have on-chip memory 846′. In some aspects, the CU 110 may further include an additional module of memory 856 and/or a communications interface 848, both of which may be coupled to the CU processor 846. The CU 110 can communicate with the DU 108 through a midhaul link 162, such as an F1 interface between the communications interface 848 of the CU 110 and a communications interface 828 of the DU 108.

The DU 108 may include a DU processor 826, which may have on-chip memory 826′. In some aspects, the DU 108 may further include an additional module of memory 836 and/or the communications interface 828, both of which may be coupled to the DU processor 826. The DU 108 can communicate with the RU 106 through a fronthaul link 160 between the communications interface 828 of the DU 108 and a communications interface 808 of the RU 106.

The RU 106 may include an RU processor 806, which may have on-chip memory 806′. In some aspects, the RU 106 may further include an additional module of memory 816, the communications interface 808, and one or more transceivers 830, all of which may be coupled to the RU processor 806. The RU 106 may further include antennas 840, which may be coupled to the one or more transceivers 830, such that the RU 106 can communicate through the one or more transceivers 830 via the antennas 840 with the UE 102.

The on-chip memory 806′, 826′, 846′ and the additional modules of memory 816, 836, 856 may each be considered a computer-readable medium/memory. Each computer-readable medium/memory may be non-transitory. Each of the processors 806, 826, 846 is responsible for general processing, including execution of software stored on the computer-readable medium/memory. The software, when executed by the corresponding processor(s) 806, 826, 846 causes the processor(s) 806, 826, 846 to perform the various functions described herein. The computer-readable medium/memory may also be used for storing data that is manipulated by the processor(s) 806, 826, 846 when executing the software. In examples, the beam management component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 5, the beam management component 150 is configured to transmit, to a first UE and a second UE, a plurality of reference signals via a plurality of beams corresponding to a plurality of subbands. The beam management component 150 is further configured to receive, from the first UE, a first indicator of a first beam of the plurality of beams and a first subband of the plurality of subbands satisfying a first threshold. The beam management component 150 is further configured to receive from the second UE, a second indicator of the first beam of the plurality of beams and a second subband of the plurality of subbands satisfying a second threshold, the second subband being different from the first subband. The beam management component 150 is further configured to communicate, with the first UE in a slot, a first communication via the first beam and the first subband. The beam management component 150 is further configured to communicate, with the second UE in the slot, a second communication via the first beam and the second subband.

The beam management component 150 may be within one or more processors of the one or more network entities 104, such as the RU processor 806 (e.g., at 150a), the DU processor 826 (e.g., at 150b), and/or the CU processor 846 (e.g., at 150c). The beam management component 150a-150c may be one or more hardware components specifically configured to carry out the stated processes/algorithm, implemented by one or more processors 806, 826, 846 configured to perform the stated processes/algorithm, stored within a computer-readable medium for implementation by the one or more processors 806, 826, 846, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication performed by a network entity, the method including transmitting, to a first UE and a second UE, a plurality of reference signals via a plurality of beams corresponding to a plurality of subbands, receiving, from the first UE, a first indicator of a first beam of the plurality of beams and a first subband of the plurality of subbands satisfying a first threshold, receiving, from the second UE, a second indicator of the first beam of the plurality of beams and a second subband of the plurality of subbands satisfying a second threshold, the second subband being different from the first subband, communicating, with the first UE in a slot, a first communication via the first beam and the first subband; and communicating, with the second UE in the slot, a second communication via the first beam and the second subband.

Example 2 may be combined with Example 1 and includes transmitting a device capability indicator request.

Example 3 may be combined with any of Examples 1-2 and further includes receiving, from at least one of the first UE or the second UE, a UE capability indicator indicating support for subband reporting.

Example 4 may be combined with Example 3 and further includes receiving the UE capability indicator indicating support for subband reporting by receiving the UE capability indicator via a PUCCH communication.

Example 5 may be combined with any of Examples 1-4 and further includes transmitting, to the first UE and the second UE, a first configuration and a second configuration, respectively, each configuration including at least one of time and frequency resources of the plurality of reference signals, a value of the first threshold or a value of the second threshold, bandwidth of the first subband and bandwidth of the second subband, or a report associated with measurements of the plurality of reference signals.

Example 6 may be combined with any of Examples 1-5 and further includes receiving, from the first UE, a first measurement report associated with the plurality of reference signals and receiving, from the second UE, a second measurement report associated with the plurality of reference signals.

Example 7 may be combined with Example 6 and further includes the first measurement report and the second measurement report include at least one of RSRP of a first subset of the plurality of reference signals having a highest RSRP, a SINR of a second subset of the plurality of reference signals having a highest SINR, or RSSI of a third subset of the plurality of reference signals having a highest RSSI.

Example 8 may be combined with any of Examples 1-7 and further includes transmitting, to the first UE based on the first indicator, downlink control information scheduling first resources associated with the first communication and transmitting, to the second UE based on the second indicator, downlink control information scheduling second resources associated with the second communication.

Example 9 may be combined with Example 8 and further includes the first resources indicate the slot, the first beam, and the first subband and the second resources indicate the slot, the first beam, and the second subband.

Example 10 may be combined with any of Examples 1-9 and further includes transmitting, to the first UE and the second UE, a TCI that maps an identifier of the first beam to an identifier of the first subband and a second TCI that maps the identifier of the first beam to an identifier of the second subband, respectively.

Example 11 may be combined with any of Examples 1-10 and further includes the first communication includes a first downlink communication and the second communication includes a second downlink communication or the first communication includes a first uplink communication and the second communication includes a second uplink communication.

Example 12 may be combined with any of Examples 1-11 and further includes the first threshold and the second threshold are the same.

Example 13 may be combined with any of Examples 1-12 and further includes the first indicator satisfying the first threshold includes the first indicator being greater than or equal to the first threshold and the second indicator satisfying the second threshold includes the second indicator being greater than or equal to the second threshold.

Example 14 is a method of wireless communication by a UE, the method including receiving, from a network entity, a plurality of reference signals via a plurality of beams corresponding to a plurality of subbands, transmitting, to the network entity, an indicator of a first beam of the plurality of beams and a first subband of the plurality of subbands satisfying a threshold and communicating, with the network entity in a slot, a first communication via the first beam and the first subband. A second communication associated with another UE is communicated in the slot, via the first beam and a second subband of the plurality of subbands, the second subband being different from the first subband.

Example 15 may be combined with Example 14 and further includes receiving, from the network entity, a device capability indicator request and transmitting, to the network entity, a UE capability indicator indicating support for subband reporting.

Example 16 may be combined with Example 15 and further includes transmitting the UE capability indicator by transmitting the UE capability indicator via a physical uplink control channel (PUCCH) communication.

Example 17 may be combined with any of Examples 14-16 and further includes receiving, from the network entity, a configuration associated with at least one of time and frequency resources of the plurality of reference signals, a value of the threshold, bandwidth of the first subband and bandwidth of the second subband, or a report associated with measurements of the plurality of reference signals.

Example 18 may be combined with Example 17 and further includes transmitting, to the network entity, the report associated with the measurements of the plurality of reference signals.

Example 19 may be combined with Example 17 and further includes the measurements include at least one of a RSRP of a subset of the plurality of reference signals having a highest RSRP, a SINR of the subset of the plurality of reference signals having a highest SINR, or a RSSI of the subset of the plurality of reference signals having a highest RSSI.

Example 20 may be combined with any of Examples 14-19 and further includes receiving, from the network entity based on the indicator, downlink control information scheduling resources associated with the first communication.

Example 21 may be combined with Example 20 and further includes the resources indicate the slot, the first beam, and the first subband.

Example 22 may be combined with any of Examples 14-21 and further includes receiving, from the network entity, a first TCI that maps an identifier of the first beam to an identifier of the first subband. A second TCI maps the identifier of the first beam to an identifier of the second subband.

Example 23 may be combined with any of Examples 14-22 and further includes the first communication includes a first downlink communication and the second communication includes a second downlink communication or the first communication includes a first uplink communication and the second communication includes a second uplink communication.

Example 24 may be combined with any of Examples 14-23 and further includes the indicator satisfying the threshold includes the indicator being greater than or equal to the threshold.

Example 25 is an apparatus for wireless communication for implementing a method as in any of Examples 1-24.

Example 26 is an apparatus for wireless communication including means for implementing a method as in any of Examples 1-24.

Example 27 is a non-transitory computer-readable medium storing computer executable code, the code when executed by a processor causes the processor to implement a method as in any of Examples 1-24.

What is claimed is:

1. A method of wireless communication performed by a network entity, the method comprising:
transmitting, to a first user equipment (UE) and a second UE, a plurality of reference signals via a plurality of beams corresponding to a plurality of subbands;
receiving, from the first UE, a first indicator of a first beam of the plurality of beams and a first subband of the plurality of subbands satisfying a first threshold;
receiving, from the second UE, a second indicator of the first beam of the plurality of beams and a second subband of the plurality of subbands satisfying a second threshold, the second subband being different from the first subband;
communicating, with the first UE in a slot, a first communication via the first beam and the first subband; and
communicating, with the second UE in the slot, a second communication via the first beam and the second subband.

2. The method of claim 1, further comprising:
transmitting a UE capability indicator request; and
receiving, from at least one of the first UE or the second UE, a UE capability indicator indicating support for subband reporting.

3. The method of claim 1, further comprising:
transmitting, to the first UE and the second UE, a first configuration and a second configuration, respectively, each configuration including at least one of:
identifiers associated with the plurality of beams;
time and frequency resources of the plurality of reference signals;
a value of the first threshold or a value of the second threshold;
bandwidth of the first subband and bandwidth of the second subband; or
a report associated with measurements of the plurality of reference signals.

4. The method of claim 1, further comprising:
receiving, from the first UE, a first measurement report associated with the plurality of reference signals; and
receiving, from the second UE, a second measurement report associated with the plurality of reference signals, wherein the first measurement report and the second measurement report comprise at least one of:
a reference signal received power (RSRP) of a first subset of the plurality of reference signals having a highest RSRP;
a signal-to-interference plus noise ratio (SINR) of a second subset of the plurality of reference signals having a highest SINR; or
a received signal strength indicator (RSSI) of a third subset of the plurality of reference signals having a highest RSSI.

5. The method of claim 1, further comprising:
transmitting, to the first UE based on the first indicator, downlink control information scheduling first resources associated with the first communication; and
transmitting, to the second UE based on the second indicator, downlink control information scheduling second resources associated with the second communication, wherein:
the first resources indicate the slot, the first beam, and the first subband; and
the second resources indicate the slot, the first beam, and the second subband.

6. The method of claim 1, further comprising:
transmitting, to the first UE and the second UE, a first transmission configuration indicator (TCI) that maps an identifier of the first beam to an identifier of the first subband and a second TCI that maps the identifier of the first beam to an identifier of the second subband, respectively.

7. The method of claim 1, wherein:
the first communication comprises a first downlink communication and the second communication comprises a second downlink communication; or
the first communication comprises a first uplink communication and the second communication comprises a second uplink communication.

8. The method of claim 1, wherein the first threshold and the second threshold are the same.

9. The method of claim 1, wherein the first indicator satisfying the first threshold includes the first indicator being greater than or equal to the first threshold and the second indicator satisfying the second threshold includes the second indicator being greater than or equal to the second threshold.

10. A method of wireless communication performed by a user equipment (UE), the method comprising:
receiving, from a network entity, a plurality of reference signals via a plurality of beams corresponding to a plurality of subbands;
transmitting, to the network entity, an indicator of a first beam of the plurality of beams and a first subband of the plurality of subbands satisfying a threshold; and
communicating, with the network entity in a slot, a first communication via the first beam and the first subband, wherein a second communication associated with another UE is communicated in the slot, via the first beam and a second subband of the plurality of subbands, the second subband being different from the first subband.

11. The method of claim 10, further comprising:
receiving, from the network entity, a UE capability indicator request; and
transmitting, to the network entity, a UE capability indicator indicating support for subband reporting.

12. The method of claim 10, further comprising:
receiving, from the network entity, a configuration associated with at least one of:
identifiers associated with the plurality of beams;
time and frequency resources of the plurality of reference signals;
a value of the threshold;
bandwidth of the first subband and bandwidth of the second subband; or
a report associated with measurements of the plurality of reference signals.

13. The method of claim 10, further comprising:
transmitting, to the network entity, a report associated with measurements of the plurality of reference signals, wherein:
the measurements comprise at least one of:
a reference signal received power (RSRP) of a subset of the plurality of reference signals having a highest RSRP;
a signal-to-interference plus noise ratio (SINR) of the subset of the plurality of reference signals having a highest SINR; or
received signal strength indicator (RSSI) of the subset of the plurality of reference signals having a highest RSSI.

14. The method of claim 10, further comprising:
receiving, from the network entity based on the indicator, downlink control information scheduling resources associated with the first communication, wherein:
the resources indicate the slot, the first beam, and the first subband.

15. The method of claim 10, further comprising:
receiving, from the network entity, a first transmission configuration indicator (TCI) that maps an identifier of the first beam to an identifier of the first subband, wherein a second TCI maps the identifier of the first beam to an identifier of the second subband.

16. The method of claim 10, wherein:
the first communication comprises a first downlink communication and the second communication comprises a second downlink communication; or
the first communication comprises a first uplink communication and the second communication comprises a second uplink communication.

17. The method of claim 10, wherein the indicator satisfying the threshold includes the indicator being greater than or equal to the threshold.

18. An apparatus for wireless communication by a user equipment (UE), comprising:
a transceiver;
a memory; and
a processor coupled to the memory and the transceiver, the processor configured to:
receive, from a network entity, a plurality of reference signals via a plurality of beams corresponding to a plurality of subbands;
transmit, to the network entity, an indicator of a first beam of the plurality of beams and a first subband of the plurality of subbands satisfying a threshold; and
communicate, with the network entity in a slot, a first communication via the first beam and the first subband, wherein a second communication associated with another UE is communicated in the slot, via the first beam and a second subband of the plurality of subbands, the second subband being different from the first subband.

19. The apparatus of claim 18, wherein the at least one processor is further configured to:
receive, from the network entity, a configuration associated with at least one of:
identifiers associated with the plurality of beams;
time and frequency resources of the plurality of reference signals;
a value of the threshold;
bandwidth of the first subband and bandwidth of the second subband; or
a report associated with measurements of the plurality of reference signals.

20. The method of claim 18, wherein the at least one processor is further configured to:
receive, from the network entity, a first transmission configuration indicator (TCI) that maps an identifier of the first beam to an identifier of the first subband, wherein a second TCI maps the identifier of the first beam to an identifier of the second subband.
